(19) United States
(12) Patent Application Publication
(10) Pub. No.: US 2021/0150885 A1
(43) Pub. Date: May 20, 2021

(54) INTELLIGENT TRAFFIC SIGNAL CONTROL SYSTEM AND METHOD

(71) Applicant: 4IND CO., LTD., Gumi-si (KR)

(72) Inventors: Chae Soo Lee, Daegu (KR); Yeong Hun Cho, Gumi-si (KR); Mu Ho Noh, Gumi-si (KR)

(21) Appl. No.: 16/951,740

(22) Filed: Nov. 18, 2020

(30) Foreign Application Priority Data
Nov. 19, 2019 (KR) 10-2019-0148178

(51) Int. Cl. G08G 1/005; G06K 9/00; G08G 1/085

(52) U.S. Cl. CPC G08G 1/005; G08G 1/085; G06K 9/00785

(57) ABSTRACT

Disclosed herein are an intelligent traffic signal control system and method. The intelligent traffic signal control system includes: a photographing unit configured to photograph images of a predetermined area; an object detection unit configured to receive the photographed images and detect an object; an object determination unit configured to determine whether or not the detected object corresponds to a predetermined object; an event generation unit configured to generate an event in a predetermined case based on the determined object; and a traffic signal control unit configured to receive the generated event and control a traffic signal.

### CROSS-REFERENCE TO RELATED APPLICATION

This application claims the benefit of Korean Patent Application No. 10-2019-0148178 filed on Nov. 19, 2019, which is incorporated by reference herein in its entirety.

### BACKGROUND

### 1. Technical Field

The present disclosure relates generally to an intelligent traffic signal control system and method, and more particularly to an intelligent traffic signal control system and method that detect an object within a crosswalk based on photographed images, analyze the object, generate an event according to a preset algorithm, and control a traffic signal accordingly.

### 2. Description of the Related Art

In general, traffic lights are widely installed and operated on roads in order to ensure the safety of pedestrians, facilitate the passage of vehicles, and prevent traffic accidents caused by vehicles.

However, in spite of the installation of such traffic lights, human accidents are not reduced due to the carelessness or violation of traffic signals of drivers, or the carelessness or unauthorized crossing of pedestrians.

In particular, as the number of vehicles increases, the traffic of vehicles is increasing, so that it is expected that accidents on crosswalks will continue to increase.

Meanwhile, vulnerable pedestrians such as children, the elderly, or the handicapped are inexperienced in determining the movement of vehicles when crossing crosswalks and are also unable to cross crosswalks within walking times set for traffic lights. Therefore, it is considered that these vulnerable pedestrians are more likely to have traffic accidents.

Therefore, there is a demand for a traffic signal control system that enables vulnerable pedestrians to use crosswalks more easily in order to ensure the social activities of the vulnerable pedestrians.

### PRIOR ART DOCUMENTS

### Patent Documents

Patent Document 1: KR 1020120095538 A
Patent Document 2: KR 1020040016343 A

### SUMMARY

An intelligent traffic signal control system and method according to embodiments of the present disclosure have been conceived to overcome the above-described problems, and an object of the present disclosure is to provide an intelligent traffic signal control system and method that detect an object within a crosswalk based on photographed images, analyze the object, generate an event according to a preset algorithm, and control a traffic signal accordingly.

According to an aspect of the present disclosure, there is provided an intelligent traffic signal control system including: a photographing unit configured to photograph images of a predetermined area; an object detection unit configured to receive the photographed images and detect an object; an object determination unit configured to determine whether or not the detected object corresponds to a predetermined object; an event generation unit configured to generate an event in a predetermined case based on the determined object; and a traffic signal control unit configured to receive the generated event and control a traffic signal.

The photographing unit, the object detection unit, the object determination unit, the event generation unit, and the traffic signal control unit may be connected to each other and configured such that data is processed by an edge computing method.

The photographing unit may include a first photographing module configured to photograph the overall area ranging from the start of a crosswalk to the end of the crosswalk, and a second photographing module configured to photograph the state of the traffic light of the crosswalk.

The object detection unit may sample the photographed images at predetermined time intervals and predetermined spatial intervals, and may detect an object using the pixel difference between the images based on the sampled images.

The object determination unit may extract features from the detected object, and may determine whether or not the detected object corresponds to the predetermined object via a deep-learned multi-artificial neural network circuit.

The event generation unit may generate an event when it is determined via the second photographing module that the traffic light is in a red light state and it is also determined via the first photographing module that the predetermined object is waiting at the crosswalk.

The traffic signal control unit may control the traffic signal so that the traffic light changes to a green light state after a predetermined period of time.

The event generation unit may generate an event when it is determined via the second photographing module that the traffic light is in a green light state and it is also determined via the first photographing module that there has been no predetermined object at the crosswalk for a predetermined period of time.

The traffic signal control unit may control the traffic signal so that the traffic light changes to a red light state after a predetermined period of time.

The event generation unit may generate an event when it is determined via the second photographing module that the traffic light is in a red light state and it is also determined via the first photographing module that the predetermined object suddenly appears at the crosswalk.

The traffic signal control unit may control the traffic signal so that the traffic light changes to a green light state after a predetermined period of time.

According to another aspect of the present disclosure, there is provided an intelligent traffic signal control method including: photographing, by a photographing unit, images of a predetermined area; receiving, by an object detection unit, the images and detecting, by the object detection unit, an object; determining, by an object determination unit, whether or not the detected object corresponds to a predetermined object; generating, by an event generation unit, an event in a predetermined case based on the determined object; and receiving, by a traffic signal control unit, the generated event and controlling, by the traffic signal control unit, a traffic signal.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a conceptual diagram schematically showing an intelligent traffic signal control system according to an embodiment of the present disclosure;

FIG. 2 is a view illustrating the intelligent traffic signal control system according to the embodiment of the present disclosure;

FIG. 3 is a view illustrating the intelligent traffic signal control system according to the embodiment of the present disclosure; and

FIG. 4 is a flowchart showing an intelligent traffic signal control method according to an embodiment of the present disclosure.

### DETAILED DESCRIPTION

The technical spirit of the present disclosure will be described with reference to the drawings below, but this description is intended for easier understanding. The scope of the invention is not limited thereto, and the invention is defined only by the scope of the claims.

In the following description of embodiments of the present disclosure, when it is determined that detailed descriptions of known functions or configurations may unnecessarily obscure the gist of the present disclosure, the detailed descriptions will be omitted. Furthermore, the same reference numerals are used to designate the same components throughout the specification.

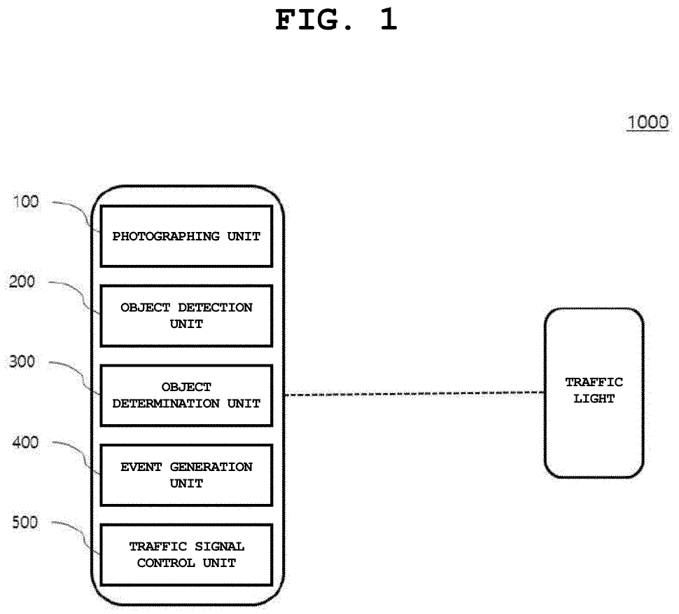

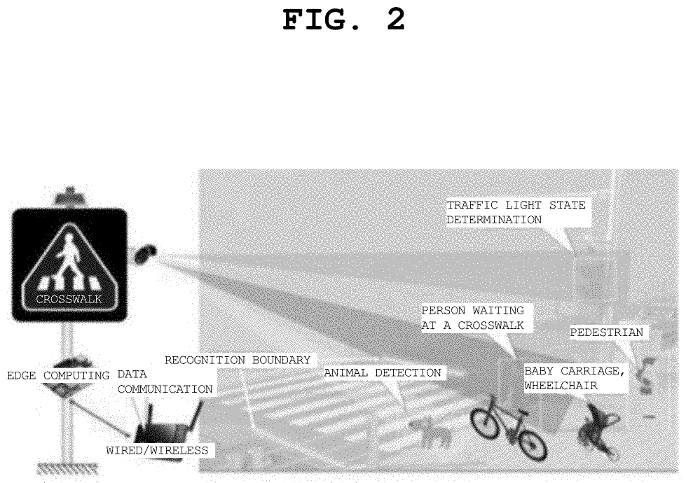

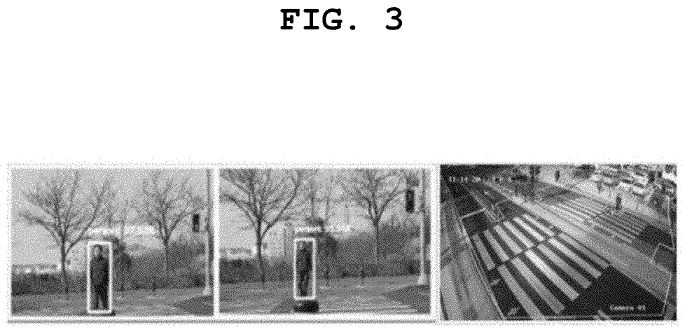

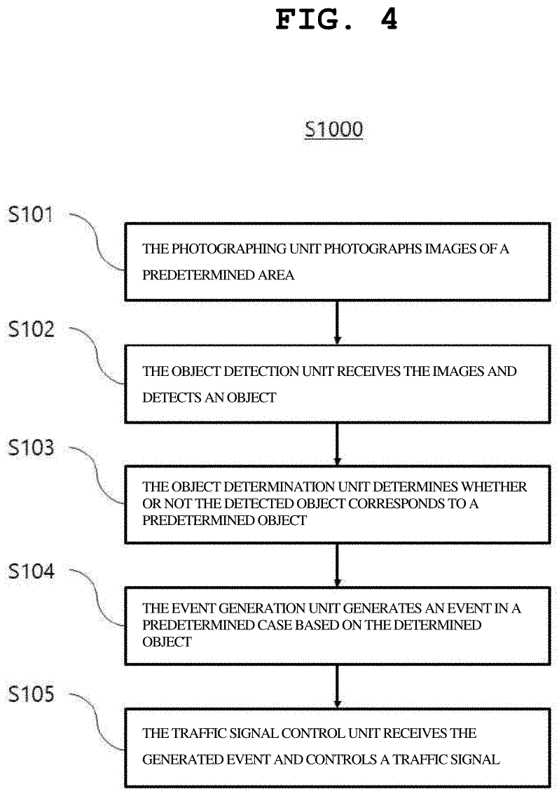

FIG. 1 is a conceptual diagram schematically showing an intelligent traffic signal control system according to an embodiment of the present disclosure, FIG. 2 is a view illustrating the intelligent traffic signal control system according to the embodiment of the present disclosure, FIG. 3 is a view illustrating the intelligent traffic signal control system according to the embodiment of the present disclosure, and FIG. 4 is a flowchart showing an intelligent traffic signal control method according to an embodiment of the present disclosure.

### <The Intelligent Traffic Signal Control System According to the Embodiment of the Present Disclosure>

Referring to FIGS. 1 to 3, the intelligent traffic signal control system according to the embodiment of the present disclosure may include a photographing unit 100, an object detection unit 200, an object determination unit 300, an event generation unit 400, and a traffic signal control unit 500.

The photographing unit 100 photographs images of a predetermined area. The photographing unit 100 may include a first photographing module configured to photograph the overall area ranging from the start of a crosswalk to the end of the crosswalk and a second photographing module configured to photograph the state of the traffic light of the crosswalk.

Although Internet Protocol (IP) cameras configured to photograph and transmit images are used as the photographing modules, the photographing modules are not limited thereto, but may be Closed-Circuit Television (CCTV) cameras or image sensors.

Meanwhile, the photographing unit 100 may further include a communication module connected over a wired or wireless connection and configured to exchange data. The photographing unit 100 may be configured to transmit photographed image data to the object detection unit 200, to be described later, through the communication module.

Furthermore, a configuration may be made such that an image photographed by the photographing unit 100 can be monitored at a remote location over a wired or wireless network.

The object detection unit 200 receives the images photographed by the photographing unit 100 and detects an object. The object detection unit 200 may be configured to sample the photographed images at predetermined time intervals and predetermined spatial intervals and to detect an object using a pixel difference between the images based on the sampled images.

The object detection unit 200 may be configured to map a predetermined section within a photographed image and to detect an object in the mapped section.

Referring to FIGS. 2 and 3, a mapped area is indicated by yellow lines around a crosswalk. The object detection unit 200 may be configured to detect an object in a mapped section but not to detect an object in an unmapped section.

The object detection unit 200 may be configured to rapidly detect an object by increasing data processing efficiency through the above-described mapping function.

The object determination unit 300 determines whether or not the detected object corresponds to a predetermined object. The object determination unit 300 may be configured to extract features from the detected object and to determine whether or not the detected object is a predetermined object based on the extracted features via a multi-artificial neural network.

The multi-artificial neural network includes data on the features of a plurality of objects in advance and has been deep-learned already. The multi-artificial neural network includes an input layer, three or less hidden layers, and an output layer. The multi-artificial neural network may be configured to be calculated and controlled to minimize a root mean square deviation between the input and output layers.

The predetermined object may include a person, a bicycle, a baby carriage, a wheelchair, and an animal, but is not limited thereto. The predetermined object may be configured to be set to one of various objects as needed.

Meanwhile, although it is preferable to use a binarization technique and a morphological technique in order to extract features from a detected object, a feature extraction method is not limited thereto, but various methods may be used as needed.

The event generation unit 400 may be configured to generate an event in a predetermined case based on the determined object.

More specifically, the event generation unit 400 may generate an event (hereinafter referred to as the “first event”) when it is determined via the second photographing module that the traffic light is in a red light state and it is also determined via the first photographing module that the predetermined object is waiting at a crosswalk.

Meanwhile, a person, a baby carriage, or a wheelchair may correspond to the predetermined object that generates the first event, but the predetermined object is not limited thereto. The predetermined object may be configured to be changed as needed.

Furthermore, the event generation unit 400 may generate an event (hereinafter referred to as the “second event”) when it is determined via the second photographing module that the traffic light is in a green light state and it is also determined via the first photographing module that there has been no predetermined object at the crosswalk for a predetermined period of time.

Moreover, the event generation unit 400 may generate an event (hereinafter referred to as the “third event”) when it is determined via the second photographing module that the traffic light is in a red light state and it is also determined via the first photographing module that the predetermined object suddenly appears at a crosswalk.

The event generated in the above manner is transmitted to the traffic signal control unit 500 to be described later.

The traffic signal control unit 500 may be configured to receive the generated event and to control a traffic signal based on the received event.

More specifically, when the first event is transmitted to the traffic signal control unit 500, the traffic signal control unit 500 may control the traffic signal so that the traffic light changes from a red light state to a green light state after a predetermined period of time.

Furthermore, when the second event is transmitted to the traffic signal control unit 500, the traffic signal control unit 500 may control the traffic signal so that the traffic light changes to a red light state after a predetermined period of time.

Moreover, when the third event is transmitted to the traffic signal control unit 500, the traffic signal control unit 500 may control the traffic signal such that the traffic light changes to a green light state after a predetermined period of time.

Meanwhile, the intelligent traffic signal control system may further include a notification provision unit (not shown) and a black box unit (not shown).

The notification provision unit (not shown) may be configured to provide a notification when an event is generated by the event generation unit 400. More specifically, the notification provision unit (not shown) may be configured to provide a notification, notifying the generation of the event, to a central server configured to control traffic signals when the event generation unit 400 generates an event.

The person concerned who has received such a notification may monitor whether or not the generation of the event is normal by checking the image photographed by the photographing unit 100.

The black box unit (not shown) puts image data, photographed by the photographing unit 100, into a database and stores the data in the database. The black box unit (not shown) may be configured to store image data, photographed by the photographing unit 100 before and after the generation of an event, in a database when the event generation unit 400 generates the event.

Accordingly, when a traffic signal is controlled by the generation of an event, an immediate notification is also provided to the person concerned with the control of the traffic signal, and the person concerned may monitor the situation of the generation of the event. Accordingly, advantages arise in that the stability of signal control is increased and the data of the black box unit (not shown) may be used as data when an accident or the like occurs.

Meanwhile, the photographing unit 100, the object detection unit 200, the object determination unit 300, the event generation unit 400, and the traffic signal control unit 500 may be connected to each other and configured such that data is processed by an edge computing method. More specifically, referring to FIG. 2, the intelligent traffic signal control system according to the present disclosure may be mounted in a sign installed at a crosswalk, and may be configured to photograph an image within the sign, to detect an object within the image, to determine whether or not the detected object is a predetermined object, to generate an event based on the results of the determination, and to control a traffic signal.

Data may be processed rapidly by the edge computing method, and thus the traffic signal may be efficiently controlled.

### <An Intelligent Traffic Signal Control Method According to an Embodiment of the Present Disclosure>

Referring to FIG. 4, the intelligent traffic signal control method according to the embodiment of the present disclosure includes:

step S101 of photographing, by the photographing unit 100, images of a predetermined area;

step S102 of receiving, by the object detection unit 200, the images and detecting, by the object detection unit 200, an object;

step S103 of determining, by the object determination unit 300, whether or not the detected object corresponds to a predetermined object;

step S104 of generating, by the event generation unit 400, an event in a predetermined case based on the determined object; and

step S105 of receiving, by the traffic signal control unit 500, the generated event and controlling, by the traffic signal control unit 500, a traffic signal.

Meanwhile, the intelligent traffic signal control method according to the embodiment of the present disclosure may further include, between steps S104 and S105,

the step of putting image data into a database in the black box unit (not shown); and

the step of providing, by the notification provision unit (not shown), a notification to a central server.

Therefore, the intelligent traffic signal control system and method according to the embodiments of the present disclosure have the advantage of efficiently controlling a traffic signal by detecting an object based on the photographing of images, analyzing the object, and generating an event according to a situation.

Furthermore, when an event is generated, a notification is also provided to the person concerned with the control of a traffic signal and the person concerned may monitor the situation of the generation of the event, thereby providing the advantage of more safely controlling the traffic signal.

Meanwhile, the intelligent traffic signal control system according to the embodiment of the present disclosure has been described in connection with a sign installed at a crosswalk, but is not limited thereto. It is obvious that the intelligent traffic signal control system may be applied in various manners as needed.

Although the above description has been given with reference to the drawings according to the embodiments of the present disclosure, a person having ordinary skill in the art to which the present invention pertains may make various applications, modifications and adaptations within the scope of the present invention based on the above-described content.

The present invention was carried out by 4IND Co. Ltd. under a Korean government research program, “2020 Artificial Intelligence Recognition and Tracking System Demonstration and Proof Track I,” by Ministry of Science and ICT and Ministry of Justice. The program was managed by Korean National IT Industry Promotion Agency under project No. A0201-20-1011, titled “Tracking System Based on Abnormal Behavior and Face Recognition with Artificial Intelligence Analysis.”

What is claimed is:

1. An intelligent traffic signal control system comprising:
a photographing unit configured to photograph images of a predetermined area;
an object detection unit configured to receive the photographed images and detect an object;
an object determination unit configured to determine whether or not the detected object corresponds to a predetermined object;
an event generation unit configured to generate an event in a predetermined case based on the determined object; and
a traffic signal control unit configured to receive the generated event and control a traffic signal.

2. The intelligent traffic signal control system of claim 1, wherein the photographing unit, the object detection unit, the object determination unit, the event generation unit, and the traffic signal control unit are connected to each other and configured such that data is processed by an edge computing method.

3. The intelligent traffic signal control system of claim 2, wherein the photographing unit comprises a first photographing module configured to photograph the overall area ranging from a start of a crosswalk to an end of the crosswalk, and a second photographing module configured to photograph a state of a traffic light of the crosswalk.

4. The intelligent traffic signal control system of claim 3, wherein the object detection unit samples the photographed images at predetermined time intervals and predetermined spatial intervals, and detects an object using a pixel difference between the images based on the sampled images.

5. The intelligent traffic signal control system of claim 4, wherein the object determination unit extracts features from the detected object, and determines whether or not the detected object corresponds to the predetermined object via a deep-learned multi-artificial neural network circuit.

6. The intelligent traffic signal control system of claim 5, wherein the event generation unit generates an event when it is determined via the second photographing module that the traffic light is in a red light state and it is also determined via the first photographing module that the predetermined object is waiting at the crosswalk.

7. The intelligent traffic signal control system of claim 6, wherein the traffic signal control unit controls the traffic signal so that the traffic light changes to a green light state after a predetermined period of time.

8. The intelligent traffic signal control system of claim 5, wherein the event generation unit generates an event when it is determined via the second photographing module that the traffic light is in a green light state and it is also determined via the first photographing module that there has been no predetermined object at the crosswalk for a predetermined period of time.

9. The intelligent traffic signal control system of claim 8, wherein the traffic signal control unit controls the traffic signal so that the traffic light changes to a red light state after a predetermined period of time.

10. The intelligent traffic signal control system of claim 5, wherein the event generation unit generates an event when it is determined via the second photographing module that the traffic light is in a red light state and it is also determined via the first photographing module that the predetermined object suddenly appears at the crosswalk.

11. The intelligent traffic signal control system of claim 10, wherein the traffic signal control unit controls the traffic signal so that the traffic light changes to a green light state after a predetermined period of time.

12. An intelligent traffic signal control method comprising:
photographing, by a photographing unit, images of a predetermined area;
receiving, by an object detection unit, the images and detecting, by the object detection unit, an object;
determining, by an object determination unit, whether or not the detected object corresponds to a predetermined object;
generating, by an event generation unit, an event in a predetermined case based on the determined object; and
receiving, by a traffic signal control unit, the generated event and controlling, by the traffic signal control unit, a traffic signal.
